(19) United States
(12) Patent Application Publication
(10) Pub. No.: US 2026/0141035 A1
(43) Pub. Date: May 21, 2026

(54) LICENSE MANAGEMENT OF FIELD DEVICES IN A PROCESS CONTROL SYSTEM

(71) Applicant: Bristol, Inc. d/b/a Remote Automation Solutions, Houston, TX (US)

(72) Inventor: Mahesh Gade, Marshalltown, IA (US)

(21) Appl. No.: 18/949,569

(22) Filed: Nov. 15, 2024

(51) Int. Cl. G06F 21/10; G06F 21/64

(52) U.S. Cl. CPC G06F 21/105; G06F 21/1013; G06F 21/64

(57) ABSTRACT

Systems, apparatus, articles of manufacture, and methods are disclosed for license management of field devices in process control systems. An example apparatus includes interface circuitry; instructions; and processor circuitry to be programmed by the instructions to: identify a field device of a plurality of field devices in a process control system; determine a first version of a license of the field device; and in response to a request to change the first version of the license to a second version of the license: compare the second version of the license to a current version of the license; enable: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and deny either transmission of the second version of the license to the field device or download of the second version of the license to the transportable memory device when the second version does not match the current version.

### FIELD OF THE DISCLOSURE

This disclosure relates generally to process control systems and, more particularly, to license management of field devices, computers, and systems in a process control system.

### BACKGROUND

Field devices in process control systems include licenses from the vendors of the field devices. The licenses relate to software operation of the field devices.

### SUMMARY

Systems, apparatus, articles of manufacture, and methods are disclosed for license management of field devices in process control systems. An example apparatus includes interface circuitry; instructions; and processor circuitry to be programmed by the instructions to: identify a field device of a plurality of field devices in a process control system; determine a first version of a license of the field device; and in response to a request to change the first version of the license to a second version of the license: compare the second version of the license to a current version of the license; enable: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and deny either transmission of the second version of the license to the field device or download of the second version of the license to the transportable memory device when the second version does not match the current version.

An example non-transitory machine-readable storage medium includes instructions to cause at least one processor circuit to at least: identify a field device of a plurality of field devices in a process control system; determine a first version of a license of the field device; and in response to a request to change the first version of the license to a second version of the license: compare the second version of the license to a current version of the license; enable: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and deny either transmission of the second version of the license to the field device or download of the second version of the license to the transportable memory device when the second version does not match the current version.

An example method includes identifying a field device of a plurality of field devices in a process control system; determining a first version of a license of the field device; receiving a request to change the first version of the license to a second version of the license; comparing the second version of the license to a current version of the license; enabling, by executing instructions with a processor: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and denying, by executing instructions with the processor, either transmission of the second version of the license to the field device or download of the second version of the license to the transportable memory device when the second version does not match the current version.

### BRIEF DESCRIPTION OF THE DRAWINGS

FIG. 1 illustrates an example process control system.

FIG. 2 is a block diagram of an example license management system in accordance with teachings of this disclosure for use in the process control system of FIG. 1.

FIGS. 3-8 are flowcharts representative of example machine-readable instructions and/or example operations that may be executed, instantiated, and/or performed by example programmable circuitry to implement the license management system of FIG. 2.

FIG. 9 is a block diagram of an example processing platform including programmable circuitry structured to execute, instantiate, and/or perform the example machine-readable instructions and/or perform the example operations of FIGS. 3-8 to implement the license management system of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 3-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Process control systems, like those used in chemical, petroleum or other processes, typically include one or more centralized process controllers communicatively coupled to at least one host or operator workstation and to one or more field devices via analog, digital or combined analog/digital buses. The field devices, which may be, for example, device controllers, valves, valve positioners, switches and transmitters (e.g., temperature, pressure and flow rate sensors), perform functions within the process control system such as opening or closing valves and measuring process parameters. A central process controller receives signals indicative of process measurements made by the field devices and/or other information pertaining to the field devices, uses this information to implement a control routine and then generates control signals that are sent over the buses or other communication lines to the field devices to control the operation of the process control system.

A company may operate several process plants, each having one or more process control systems having different configurations. Performing hardware and software maintenance on such systems can be an arduous task. Because the process control systems may be located at different plant sites at different geographical locations, system engineers may be subject to frequent travel between each plant site. Alternatively, each plant site may have system engineers responsible for maintaining the hardware and software associated with the components of a process control system. In any case, maintaining a company's process control systems often involves numerous different maintenance procedures.

Maintaining a company's process control systems often involves installation and/or updating of licenses associated with field devices in the process control systems. Owners of process controls systems often waste valuable time using undocumented, locally created methods to install updates specified by a system supplier. A user must download updates from an external system, and this process involves much time and expense. The user must also determine which updates (e.g., security updates, etc.) to install. For many known systems, licensing notices are currently sent to users, and the user manually updates the field devices one at a time. Though examples in this disclosure are described in connection with field devices, the examples apply to computers, systems, and other devices and/or applications or other software within a process control system.

Throughout this disclosure, a “license” refers to authorizations related to use of the field devices and includes, for example, access to operating software, software updates and/or upgrades, maintenance updates and/or upgrades, security updates and/or upgrades, terms of use, duration of authorization, authorized users, authorized locations, service terms, subscription terms, etc. In some examples, licenses support applications including customized applications. In some examples, a license related to software may control how many devices could be connected to a computer. In some examples, a subscription-based license related to software may control a duration during which devices could be connected (e.g., annual subscriptions). In some examples, features are licenses at an individual level (e.g., per computer) or at a system level (e.g., per server).

In some examples, licenses include device licenses. For example, different vendors may offer different types of licenses associated with their devices. In some examples the device licenses cover diagnostics such as advanced diagnostics or performance diagnostics. In some examples, the licenses are individual per device, bulk, or packages. In some examples, the licenses are application packages.

In some examples, the licenses include computer or system based licenses. For example, the license can limit the number of devices, or days (i.e., subscription). In some examples, the licenses are offered for certain features. In some examples, the licenses related to software that is tied to a specific hardware, a site, and/or a company. In some examples, the licenses are server based. In some examples, the licenses limit the number of simultaneous users.

Throughout this disclosure, “user,” “customer,” “owner,” and/or “operator” may be used interchangeably.

Disclosed herein is license management that enables users to centrally manage licenses of field devices. Examples disclosed herein enable users to obtain a comprehensive inventory of field devices and associated licenses including which licenses are in sync with (or matching) current licenses and which licenses are expired, out-of-date, or out of sync with (otherwise not matching) the current licenses. Current licenses are the most recently released or otherwise available versions of the respective license. Examples disclosed herein relieve users of the need to audit all field devices when updating or upgrading one or more of the field devices. In addition, examples disclosed herein enable users to update or upgrade licenses wirelessly or via transportable memory devices without the need for specialized, premium dongles from individual vendors for different ones of the field devices.

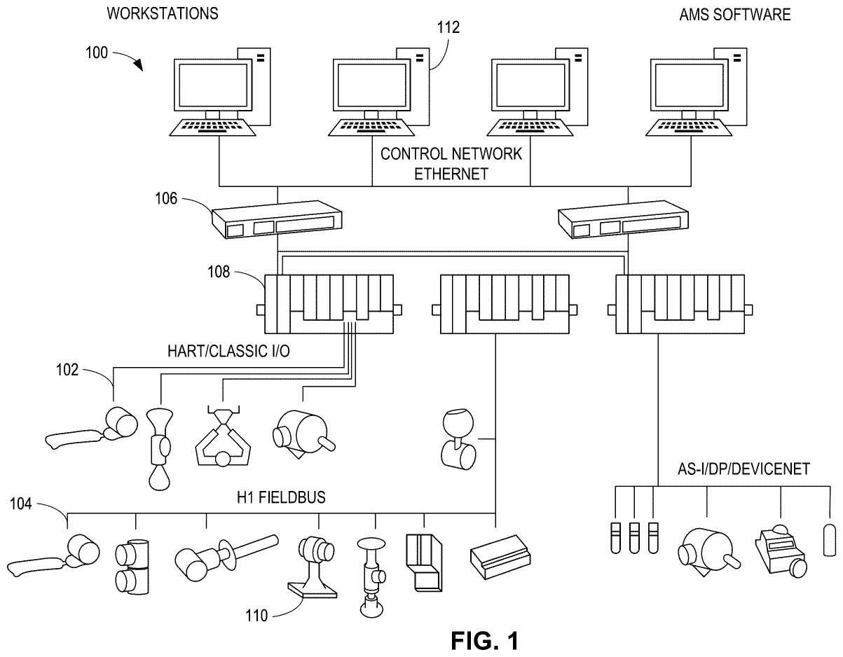

FIG. 1 illustrates an example process control system 100 usable in conjunction with the license management system disclosed herein. The example system 100 employs a digital plant process control architecture that integrates a variety of smart plant capabilities including field bus (such as HART 102 and/or FOUNDATION™ fieldbus 104), high-speed discrete busses, embedded advanced control, and advanced unit and batch management, for example. Though HART and FIELDBUS are shown in FIG. 1, other protocols may additionally or alternatively be used including, for example, Distributed Network Protocol 3(DNP3 ), Bluetooth, Wi-Fi, Profibus, and other industrial protocols. Adaptive field integration provides an infrastructure for a variety of applications including device management for device re-ranging, configuration and diagnostics, for example.

The process control system 100 scales in size and/or functionality. The process control system 100 can provide plug-and-play OPC (open connectivity via open standards) and XML (extensible markup language) integration, fieldbus, batch control, and advanced control technologies, for example.

The process control system 100 can also provide varying levels of redundancy. For example, an operator can choose a level of redundancy for an application, including: 1) redundant network communications (for example, Ethernet); 2) redundant controllers; 3) redundant power supplies; 4) redundant fieldbus interfaces and bus power; 5) redundant digital I/O; 6) redundant serial communications (for example, MODBUS, RS485, etc.); and 7) redundant workstations.

The process control system 100 can provide flexible, system-wide security management for all users including operators, engineers, technicians, and other automation users based on user login, keys control system functionality and/or span of operator control. Security settings may include: 1) an operating span of control by plant area; 2) alarm limits, turning parameters change privilege; and/or 3) security by both user and by physical location for example.

The process control system 100 can also accommodate an addition of system components including controllers 106, I/O devices 108, field devices 110, and workstations 112, for example, while the system is powered and running. Thus, an operator can expand and upgrade the process control system 100 on the fly.

The process control system 100 can also support a full range of analog, discrete, thermocouple, and resistance temperature detectors (RTDs) for existing field devices, for example. The process control system 100 can include one or more sensor buses supporting installation and operation of discrete devices, such as pushbuttons, on/off valves, and proximity switches, for example. The system 100 can include one or more device buses that connect motor starters, drives, and other more complex devices, for example. The fieldbus 104, such as a FOUNDATION fieldbus, delivers predictive alerts, millisecond data capture, validated data, field-based control, diagnostics, and asset information bi-directionally within the digital automation system to help predict maintenance problems before they occur.

Devices can be automatically recognized by the process control system 100 as the devices are added, for example. The process control system 100 can coordinate aspects of automation engineering including but not limited to control strategies, process graphics, history, events, change management, and bulk editing and data entry, for example. The process control system 100 can also be used to develop types of control including but not limited to logic, regulatory, sequential, and advanced control, for example. The process control system 100 can further include one or more libraries of pre-defined control strategies, stress-tested digital bus devices files, etc.

The process control system 100 can provide digital automation systems with validated data, displaying quality, status, and diagnostics from field devices. As an example, alarm management is built on EEMUA 191, developed by a consortium of leading process industry automation users and suppliers, and designed to eliminate nuisance alarms. In particular, the process control system 100 can support EEMUA 191 standards by allowing operator suppression of alarms; time-stamp and history of suppressed alarms; removing suppressed alarms from alarm banner and alarm summary; and/or maintaining a suppressed alarm summary, for example.

Example methods and systems disclosed herein involve using an example license management system that is communicatively coupled to one or more remotely located process control systems and configured to monitor various aspects of the process control system. For example, the example license management system may be implemented using one or more management servers at a central facility executing machine accessible instructions (e.g., computer code, software, etc.) that cause the management servers to communicate via the Internet and/or other communication network(s) (e.g., a local area network (“LAN”), a wireless LAN (“WLAN”), a wide area network (“WAN”), etc.) and/or an air-gapped network with one or more remotely located process control system servers and that cause the management servers to obtain process control system information (e.g., performance information, operating information, etc.) from the process control system servers.

The example license management system disclosed herein may analyze the process control system information to determine whether licensing changes are available for any portion of the one or more process control systems. The process control system information may be indicative of various types of operating conditions of each process control system including, for example, the software and/or firmware executed by the equipment in each process control system, any equipment failures within the systems, operating efficiencies, part numbers and manufacturers of equipment used to implement the systems, and/or many other types of operating conditions. To detect whether licensing changes are available, in some example implementations, the license management system surveys field devices, obtains license information, and compares the existing license information of the field devices with the current license (i.e., the most recently released or available) from the vendors of the field devices. In some examples, the license management system detects whether a license change is available upon a request to change the license of a field device by the user.

The license management system may be implemented using a cloud-based and/or web-based interface such as, for example, a web-based portal. In some example implementations, users may access the license management systems via virtually any computer system having network access.

The license management system may also be implemented to provide a plurality of other features. For example, the license management system may be configured to send alerts via e-mail, mobile phone, landline phone, really simple syndication (“RSS”), etc. to users (e.g., system operators, system engineers, maintenance engineers, etc.) if one or more particular conditions are met (e.g., a failure condition, a change in software or hardware, availability of firmware updates or software upgrades, etc.). The example license management system may also generate maintenance reports, monitor the lifecycle status of portions of the process control systems, organize and track information (e.g., expiration dates) associated with product warranty and support services, store and display status of open maintenance tickets or maintenance calls, and other features disclosed herein.

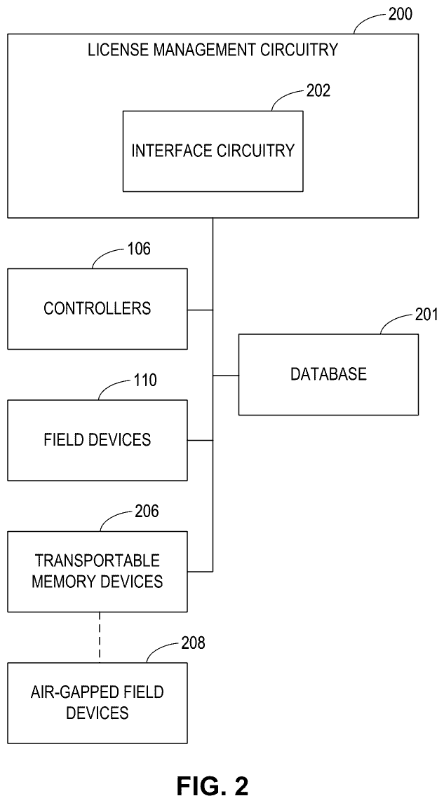

FIG. 2 is a block diagram of an example implementation of a license management system including example license management circuitry 200 that can be implemented in the process control system 100 of FIG. 1 to manage licenses of the field devices 110 and/or other components of the process control system 100. The license management system of FIG. 2 may be instantiated (e.g., creating an instance of, bring into being for any length of time, materialize, implement, etc.) by programmable circuitry such as a Central Processor Unit (CPU) executing first instructions. Additionally or alternatively, the license management system of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

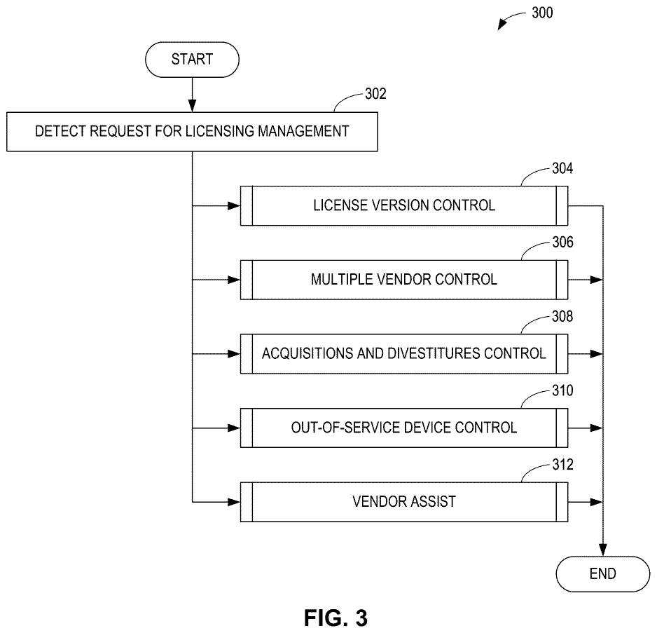

In some examples, the license management circuitry 200 is instantiated by programmable circuitry executing license management instructions and/or configured to perform operations such as those represented by the flowchart(s) of FIGS. 3-8.

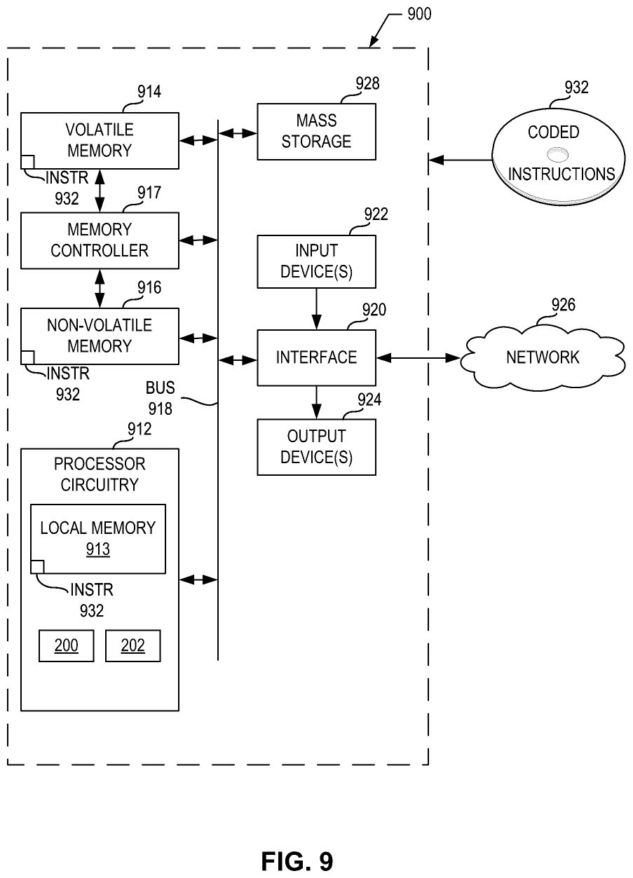

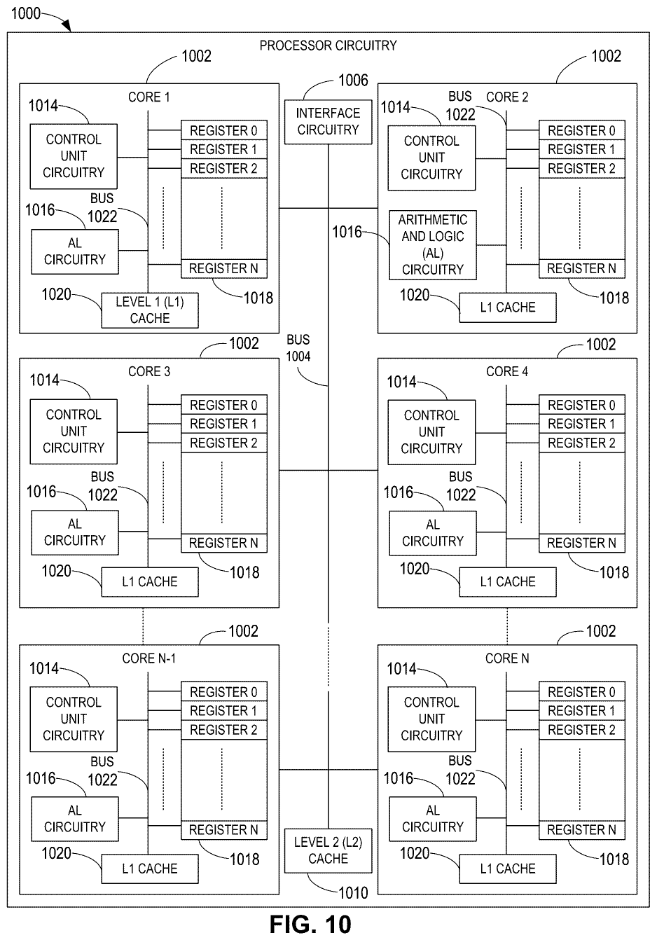

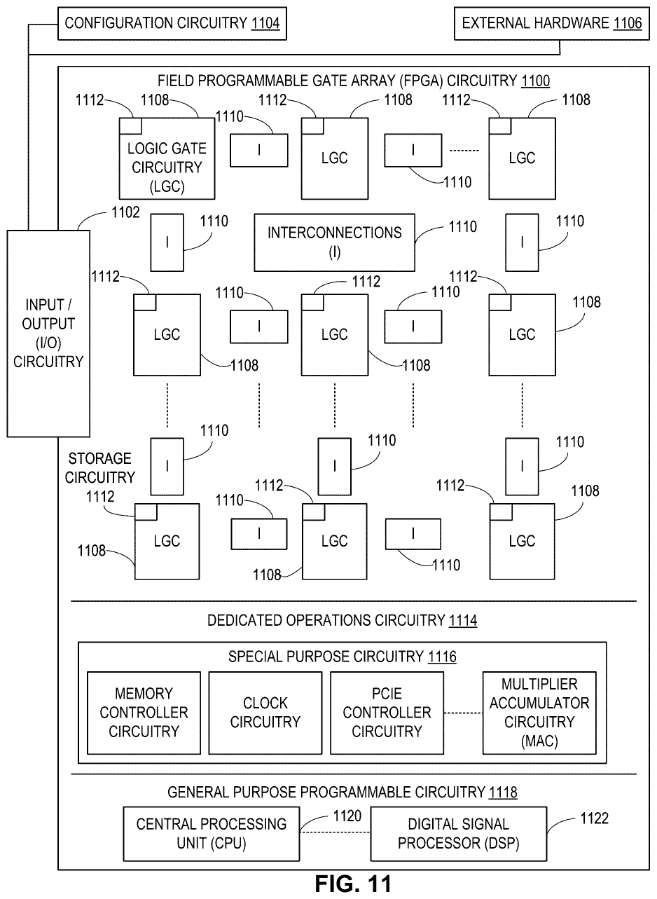

In some examples, the license management system includes means for managing license(s) of a device. For example, the means for managing may be implemented by license management circuitry 200. In some examples, the license management circuitry 200 may be instantiated by programmable circuitry such as the example programmable circuitry 912 of FIG. 9. For instance, the license management circuitry 200 may be instantiated by the example microprocessor 1000 of FIG. 10 executing machine executable instructions such as those implemented by the blocks of FIGS. 3-8. In some examples, license management circuitry 200 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the license management circuitry 200 may be instantiated by any other combination of hardware, software, and/or firmware. For example, the license management circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example license management system of FIG. 2 includes the license management circuitry 200, example interface circuity 202, and an example database 204. The interface circuity 202 receives and transmits communications between the license management circuitry 200 and one or more of the controllers 106, the field devices 110, transportable memory devices 206, and/or the database 204. In some examples, the license management circuitry 200 includes the database 204. In other examples, the database 204 is communicatively coupled with the license management circuitry 200 via wired or wireless connection. In some examples, the database 204 is cloud-based.

The transportable memory devices 206 include, for example, electronic hardware that can be connected to the interface circuitry 202 to obtain data, information, etc. Example transportable memory devices 206 include dongles, flash drives, memory sticks, portable disk drives, portable disks, compact discs, and other peripheral appliances. The transportable memory device 206 can be disconnected from the interface circuitry 202 and physically transferred to the field devices 110 or air-gapped field devices 208. Air-gapped field devices 208 include field devices 208 that are not connected to a network to which the license management circuitry 200 is connected. Air-gapped field devices 208 may be connected to other air-gapped devices in a physically isolated network or environment but are not coupled to outside networks such as, for example, via the internet. In some examples, the license management circuitry 200 communicates with air-gapped devices via other communication means such as, for example, telephone, email, text, fax, etc.

The license management circuitry 200 performs many functions including, for example, controlling the versions of licenses installed on the field devices 110, 208, controlling the use of the field devices 110, 208 from multiple vendors of field devices in the process control system 100, controlling data aggregation for use in acquisitions and divestitures, controlling license allocation with out-of-service devices, and providing assistance to vendors.

Vendors may update versions of licenses for the field devices 110, 208 over time to provide enhanced functionality, extend authorization periods, change user authorization, etc. Over time, the versions of licenses on field devices may become out of sync with the latest or more current versions of the license offered by the vendors. The licenses may become out of sync with the current version when the field device 110, 208 has not been updated. In other examples, the license may become out of sync because a technician may have multiple files in their system and uses an out of date or out of sync file to update the field device 110, 208. In these situations, the version of the license on the field device 110, 208 will be inconsistent with the current version of the license.

The license management circuitry 200 determines an existing version of the license on the field device 110, 208 and compares the existing version of the license with the current version of the license. Current versions of licenses across multiple field devices 110, 208 in the process control system 100 can be stored in the database 204. The license management circuitry 200 can identify if the existing version of the license is out of sync with the current version of the license. The license management circuitry 200 can issue an alter to the user that an update of the license is available when the existing version of the license is out of sync with the current version of the license. In some examples, the license management circuitry 200 can survey multiple fields devices 110, 208 in the process control system 100, identify field devices with out of sync versions of the respective licenses and generate a report indicating which of the field devices 110, 208 are in condition for an update in the version of the license. The report can be generated by a site in the process control system 100, select sites, and/or for the entire company. This will help the user/customer to ensure that their technicians apply the licenses correctly, perform any desired audits, and avoid visiting all devices in the field and instead focus only on those devices that are not in sync.

In some examples, the license management circuitry 200 receives a request from a user to update the version of the license on a field device. The license management circuitry 200 compares the requested version of the license to the current version of the license. If the requested version of the license is older than the current version of the license, the license management circuitry 200 generates a message to alert the user that the requested version of the license is not the current version of the license. In this example, the license management circuitry 200 will not authorize and denies the update to the requested version of the license. In some examples, when the requested version of the license does not match the current version of the license, the license management circuitry 200 transmits or enables download of the current version of the license despite the request for a different version of the license. Thus, the license management circuitry 200 provides tamper-proof protection by only authorizing the updates to the current version of the license. For example, a field device 110, 208 may have License v:1.10. A user may send a request to the license management circuitry 200 to update the field device 110, 208 with License v:2.2. The license management circuitry 200 verifies the current version of the license, which is, in this example, determined to be License v:4.3. Because, in this example, the user requested a version of the license that is older than the most recent version, the license management circuitry 200 will issue an alert to the user. The license management circuitry 200 will authorize the update to the latest or most current version of the license. In this example, that would be License v:4.3. This feature eliminates the potential mistakes performed by the technicians in the field, thereby reducing inconsistencies in license versions across devices, loss of productivity due to a reduced set of licenses at the devices, and additional costs involved with performing an audit of each device and visits to each device.

When the requested version of the license matches the current version of the license, the license management circuitry 200 enables transmission of the current version of the license (which is the requested version of the license in this example) to the connected field device 110 via a wired or wireless communication link.

In examples, where the field device 208 is air-gapped, the license management circuitry 200 enables transmission of the current version of the license (which, again, is the requested version of the license in this example). However, the transmission occurs as a download to the transportable memory device 206. Prior to, concurrently, or after the download to the transportable memory device 206, the license management circuitry 200 generates a hash signature. In some examples, the hash signature is generated based on the current version of the license and the serial number of the air-gapped field device 208. The hash signature is an encoding that secures the transfer of the current version of the license to the air-gapped field device 208 and provides protection against tampering. In addition, the hash signature enables users to use the transportable memory device 208 of their choosing rather than relying on expensive, special dongles provided by vendors.

The transportable memory device 206 is carried to the air-gapped field device 208 and used to transfer the current version of the license to the air-gapped field device 208. The hash signature at the air-gapped field 208 is confirmed with the hash signature generated by the license management circuitry 200 and stored in the database 204 after the technician returns from the field and/or via communication means such as, for example, email, a text, a phone call, fax, etc. If the transportable memory device 206 is lost, the hash signature can be recreated.

The examples disclosed herein for the air-gapped field devices 208 may also be used at sites in the process control system 100 that are remote and/or has little to no internet connectivity. In such examples, the use of the transportable memory device 206 may provide more reliable transfer of the current version of the license.

With respect to controlling the use of field devices 110, 208 from multiple vendors of field devices in the process control system 100, the license management circuitry 200 enables users to aggregate field devices 110, 208 from multiple vendors. For example, a user may purchase field devices 110, 208 from an authorized partner, an original device manufacturer, a third-party reseller, a system integrator, etc. Different vendors may or may not transfer registration of devices to the user upon sale and/or installation. For example, some authorized partner transfer device registration to the users at the time of sale, while some third-party resellers and/or system integrators maintain their customers'identities confidential.

The license management circuitry 200 associates different vendors with a user of the process control system 100. The license management circuitry 200 can detect a field device 110, 208 that is not registered with a user. If the license management circuitry 200 detects an unregistered field device 110, 208, the license management circuitry 200 alerts the user, authenticates the user, and then transfers or allocates the previously unregistered field device 110, 208 to the user. Thus, users have the flexibility to mix and match licenses from partners, third-party resellers, system integrators, and/or other vendors. Once the licenses, field devices, or other products are purchased by the user, those become assets of the user irrespective of the source of the seller (i.e., the vendor) and any confidentiality asserted by such vendor.

The license management circuitry 200 also allows the user to choose a specific vendor or list of vendors who could help the user in the event of any technical difficulties, thereby allowing the user to seek service from a specific vendor even though the user may have purchased licenses from different vendors located at different geographic areas. In other words, the user can appoint a servicing agent for one or more of the field devices 110, 208, regardless of the provenance of the field device 110, 208. The different licenses from different vendors, the servicing agent appointment, and other data disclosed herein can be stored in the database 204.

With respect to controlling data aggregation for use in acquisitions and divestitures, license management circuitry 200 can compile a list of all assets and associated licenses in the process control system 100. The license management circuitry 200 can add metadata to the listing that includes data related to, for example, device type, vendor type, device service history, geographic regions of the process control system 100, device owner, device user or operator, etc. The license management circuitry 200 can generate reports based on one or more of the categories of the metadata. This data may be used to identify assets when organizations are being acquired or merged and/or when assets of an organization or being divested.

In some examples, the license management circuitry 200 generates a CSV file as the report. For example, the CSV file content (or content of reports in other formats) may include one line with keywords to specify the type of merger, source, and the destination sites or companies. In other examples, the report can be more granular. For example, a partial merger of a site or a company can include more detail. The report can contain details related to assets such as, for example, move the entire company, move one or more sites, and/or move partial assets from one or more sites. In addition, the report can contain details related to users such as, for example, move all users or partial list of users. In some examples, the report includes details related to changes in contact information such as email addresses (i.e., old company to the new company) while leaving the privileges unchanged for the sites. Different combinations of data can be included the reports based on the type of acquisition or divestiture. In some examples, the content of the report can be reviewed, modified, and approved by the customer. In such examples, changes made by the customer can be applied to the system in a matter of seconds, which eliminates the lengthy, time consuming, expensive steps and/or surgical corrections involved in applying the changes in support acquisition and/or divesture activity. In some examples, input errors (e.g., typographic errors) in an initial or subsequent upload of the data via file also can be readily corrected.

The license management circuitry 200 can also control license allocation with and/or recovery from out-of-service devices. Out-of-service devices can include devices that are damaged and cannot be accessed. For example, a device may be damaged, rendered inoperable, and taken out of service. The license for the damaged device may still be valid. The license management circuitry 200 enables a credit and/or transfer of the license associated with the out-of-service device. In some examples, if a device is marked as out-of-service and the license management circuitry 200 detects connectivity with such device, the user is alerted. In such example, the license management circuitry 200 may prevent or reverse crediting and/or transfer of the license associated with such device.

The license management circuitry 200 can also provide assistance to vendors. For example, the license management circuitry 200 may enable vendors to update licenses on the field device 110, 208 prior to the sale and/or installation of the field devices 110, 208 with the customer or user. In such example, the field device 110, 208 can be sold and/or installed with the user with current licenses. This saves all parties the time and effort to later update the licenses after installation.

In addition, during the sale or installation of the field devices 110, 208, a vendor may have an input error such as typographical error. The license management circuitry 200 enables reversal of the error and recovery or credit of any license that may have been associated with an order that included the input error.

While an example manner of implementing the license management system is illustrated in FIG. 2, one or more of the elements, processes, and/or devices illustrated in FIG. 2 may be combined, divided, re-arranged, omitted, eliminated, and/or implemented in any other way. Further, the license management circuitry 200 and the example interface circuitry of FIG. 2, may be implemented by hardware alone or by hardware in combination with software and/or firmware. Thus, for example, the license management circuitry 200, the example interface circuitry 202, and/or, more generally, the example license management system, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example license management system of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the license management system of FIG. 2 and/or representative of example operations which may be performed by programmable circuitry to implement and/or instantiate the license management system of FIG. 2, are shown in FIGS. 3-8. The machine-readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-8, many other methods of implementing the example license management system may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to manage licenses of field devices 110, 208 in a process control system 100. The example machine-readable instructions and/or the example operations 300 of FIG. 3 include the license management circuitry 200 detecting a request for licensing management (block 302). The request may be from, for example, an owner or user of a field device 110, 208 or a vendor of a field device 110, 208 attempting to update a license of the field device 110, 208. The include the license management circuitry 200 performs multiple functions for different aspects of licensing management including license version control (block 304), multiple vendor control (block 306), acquisitions and divestitures control (block 308), out-of-service device control (block 310), and vendor assist (block 312). These different functions are disclosed in more detail herein.

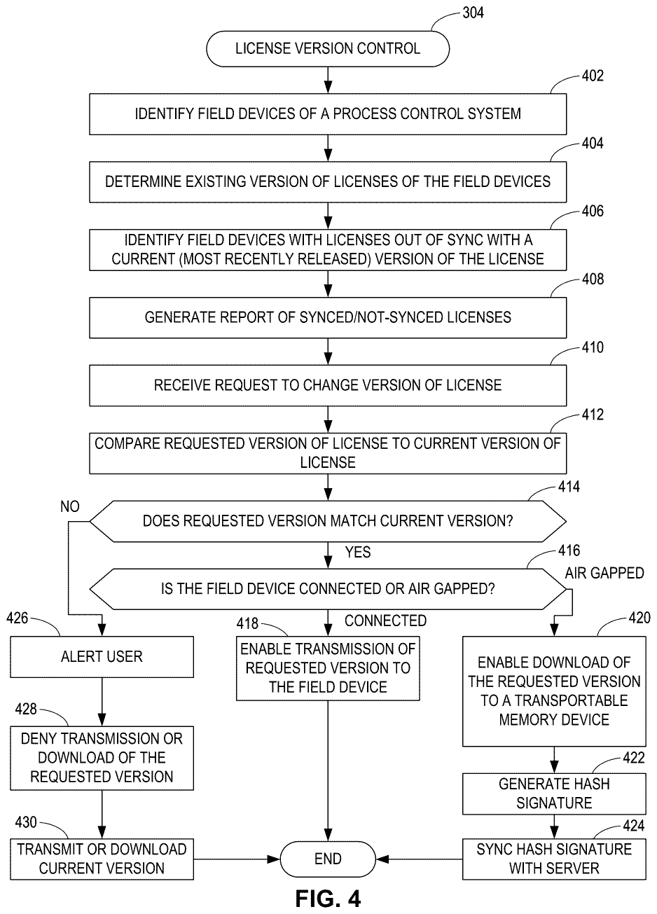

FIG. 4 is a flowchart representative of example machine-readable instructions and/or example operations 304 that may be executed, instantiated, and/or performed by programmable circuitry to such as, for example, license management circuitry 200, to control the version of licenses in field devices 110, 208 in a process control system 100. The license management circuitry 200 identifies field devices 110, 208 of a process control system 100 (block 402). The license management circuitry 200 determines existing (or first) versions of licenses of the respective field devices 110, 208 (block 404).

In some examples, the license management circuitry 200 identified field devices 110, 208 with licenses that are out of sync with a current version (i.e., most recently released version) of the respective license (block 406). In some examples, the license management circuitry 200 generates a report of the synced field devices 110, 208, which have licenses that match the current version of the license, and/or of the out-of-sync field device 110, 208 (block 408).

The license management circuitry 200 receives, e.g. via the interface circuitry 202, a request to change the existing (or first) version of the license to a requested (or second) version of the license for the field device 110, 208 (bock 410). The license management circuitry 200 compares the requested (or second) version of the license to the current version of the license (block 412). The license management circuitry 200 determines if the requested (or second) version of the license matches the current version of the license (block 414). If and/or when the requested (or second) version of the license matches the current version of the license (block 414: YES), the license management circuitry 200 determines if the field device 110, 2087 is connected via a wired or wireless communication channel or air-gapped (block 416). If and/or when the license management circuitry 200 determines that the field device 110 is connected (block 416: CONNECTED), the license management circuitry 200 enables transmission of the requested (or second) version, which is the current version of the license) to the field device 110, 208 (block 418). In this example, the process 304 then ends.

If and/or when the license management circuitry 200 determines that the field device 208 is air-gapped (block 416: AIR-GAPPED), the license management circuitry 200 enables download of the requested (or second) version of the license, which is the current version of the of the license, the transportable memory device 206 (block 420). The license management circuitry 200 generates a hash signature to associate with the air-gapped field device 208 and the current version of the license to secure transfer of the current version of the license to the air-gapped field device 208 (block 422). In some examples, the hash signature is saved to a temporary storage and/or conveyed (e.g., via telephone, text, email, or fax) to a central office for uploading to a server to confirm that the current version of the license has been downloaded to the field device correctly. Thus, in some examples, the hash signature is synced with the server (block 424). In some examples, the license file also may be communicated via email, telephone, text, and/or fax (or other communication means) without the need for transportable memory device based on the customer need or desire. For example, some customer sites may be located at a remote location that may not have good transportation system for handling transportable memory devices. In this example, the process 304 then ends.

If and/or when the license management circuitry 200 determines that the requested (or second) version of the license does not match the current version of the license (block 414: NO), the license management circuitry 200 alerts or causes an alert to be presented to the user (block 426). The alerts informs the user that the requested (or second) version of the license is not the most current version of the license. The license management circuitry 200 then denies the transmission or download of the requested (or second) version of the license (block 428). In some examples, the license management circuity 200 transmits or enables download of the current version of the license despite the current version of the license being different from the requested version (block 430). In some examples, the user is provided with a notification that the current version of the license was downloaded or transmitted. In this example, the process 304 then ends.

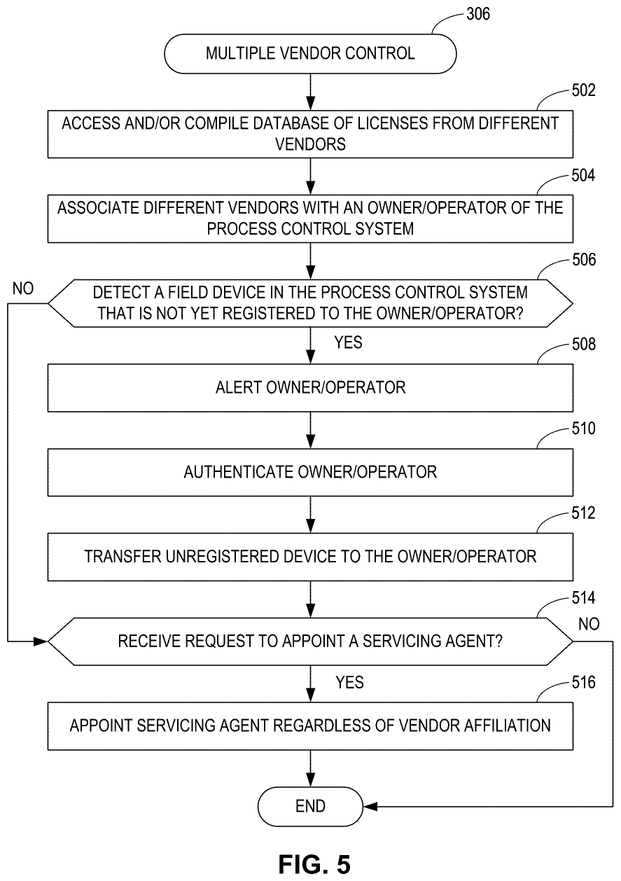

FIG. 5 is a flowchart representative of example machine-readable instructions and/or example operations 306 that may be executed, instantiated, and/or performed by programmable circuitry to such as, for example, license management circuitry 200, to control the use and support of multiple vendors of field devices 110, 208 in a process control system 100. The license management circuitry 200 accesses and/or compiles the database 204 that includes licenses from different vendors (block 502). The license management circuitry 200 associated different vendors with a user, an owner or operator of the process control system 100 (block 504). The license management circuitry 200 detects if a field device 110, 208 in the process control system 100 is not yet registered or allocated to the owner or operator (block 506). If and/or when the license management circuitry 200 detects that a field device 110, 208 is not registered to the owner or operator (block 506: YES), the license management circuitry 200 alters the owner or operator of the unregistered field device 110, 208 (block 508). The license management circuitry 200 authenticates the owner or operator (block 510). The license management circuitry 200 transfer the previously unregistered field device 110, 208 to the owner or operator (block 512).

The license management circuitry 200 determines if a request to appoint a servicing agent is received (block 514). If and/or when the license management circuitry 200 determines that a request to appoint a servicing agent is not received (block 514: NO), the process 306 ends. If and/or when the license management circuitry 200 determines that a request to appoint a servicing agent is received (block 514: YES), license management circuitry 200 appoints the servicing agent regardless of vendor affiliation (block 516). Thus, users, owners, operators, etc. of a process control system 100 can have one or more serving agents across their field devices 110, 208 irrespective of the manufacturer, seller, or installer of such field device 110, 208. In this example, the process 306 then ends.

If and/or when the license management circuitry 200 does not detect that unregistered field devices 110, 208 (block 506: NO), the license management circuitry 200 continues the process 306 at block 514.

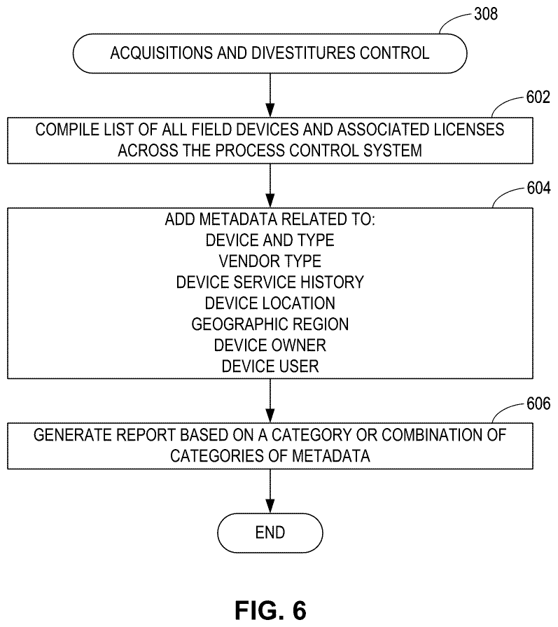

FIG. 6 is a flowchart representative of example machine-readable instructions and/or example operations 308 that may be executed, instantiated, and/or performed by programmable circuitry to such as, for example, license management circuitry 200, to control data aggregation related to acquisition and divestiture activity in regards to field devices 110, 208 in a process control system 100. The license management circuitry 200 compiles a list of some or all the fields devices 110, 208 and associated licenses across the process control system 100 (block 602). The license management circuitry 200 adds or accesses metadata related to various characteristics or other aspects of the field devices 110, 208 and/or process control system 100 (block 604). Example characteristics include device type, vendor type, device service history, device location, geographic region in the process control system, device owner, device user, etc. In some examples, to add metadata, users can change contact information (e.g., email addresses) to migrate from the old company to the new company, rename the old sites to the new sites and/or addresses, etc. The license management circuitry 200 generates one or more report based on a category or a combination of categories of the metadata (block 606). Thus, the process 600 allows selection of full or partial acquisitions using keyword and/or provides more granular selection of asset data and user data. The report may be used to complete the acquisition or divestiture. The example process 308 ends.

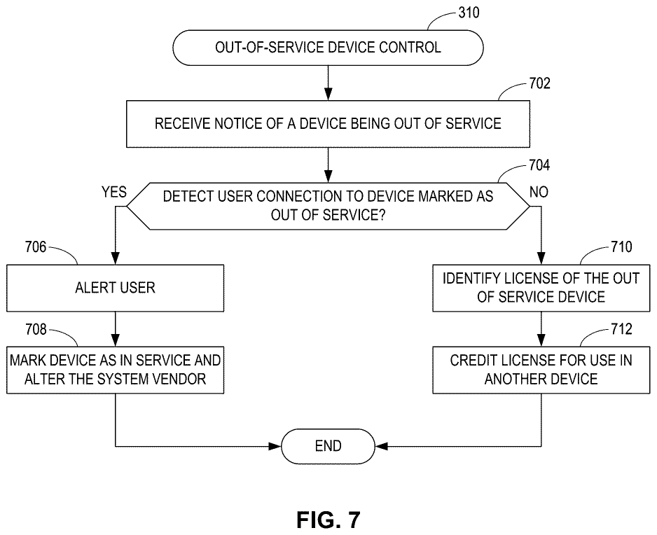

FIG. 7 is a flowchart representative of example machine-readable instructions and/or example operations 310 that may be executed, instantiated, and/or performed by programmable circuitry to such as, for example, license management circuitry 200, to control the licenses in field devices 110, 208 that are out-of-service in a process control system 100. The license management circuitry 200 receives notice of a field device 110, 208 being out of service (block 702). The license management circuitry 200 determines if there is any detected user connection to the field device 110, 208 that was marked as out-of-service (block 704).

If and/or when the license management circuitry 200 detects that a user connected with a field device 110, 208 that is marked as out-of-service (block 704: YES), the license management circuitry 200 alerts the user (block 706). The license management circuitry 200 marks the field device 110, 208 as in service and alters the system vendor (block 708). In this example, the process 310 ends.

If and/or when the license management circuitry 200 does not detect that a user connected with a field device 110, 208 that is marked as out-of-service (block 704: NO), the license management circuitry 200 identifies the license of the out-of-service field device 110, 208 (block 710). The license management circuitry 200 credits the license associated with the out-of-service field device 110, 208 for use in another field device 110, 208 (block 712). In this example, the process 310 ends.

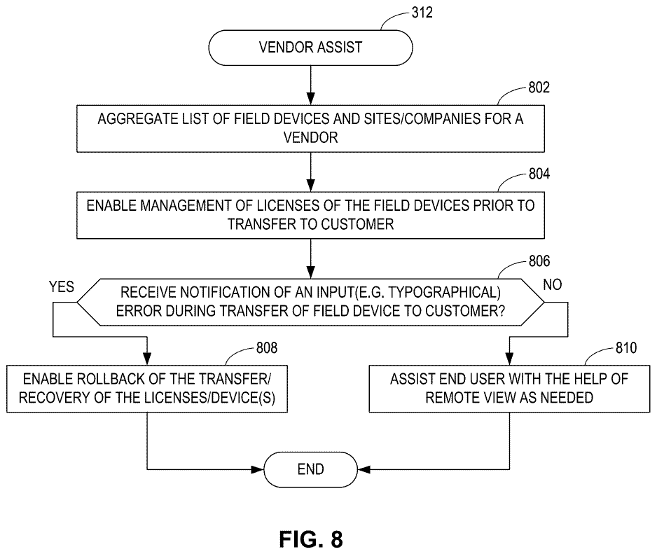

FIG. 8 is a flowchart representative of example machine-readable instructions and/or example operations 312 that may be executed, instantiated, and/or performed by programmable circuitry to such as, for example, license management circuitry 200, to assist vendors of field devices 110, 208, in a process control system 100. The license management circuitry 200 aggregates a list of field devices 110, 208, sites, and/or companies of a vendor (block 802). The license management circuitry 200 enables management of the licenses of the field device 110, 208 prior to transfer of the field devices 110, 208 to the customer (block 804). For example, the license management circuitry 200 enables the vendor to manage licenses in accordance with examples disclosed herein such as those of process 304.

The license management circuitry 200 determines if there is receipt of a notification of an input error (e.g., a typographical error) made during transfer of a field device 110, 208 to a customer (block 806). If and/or when the license management circuitry 200 receives notification of an input error (block 806: YES), the license management circuitry 200 enables rollback of the transfer and/or recovery of the associated license and/or device (block 808). Thus, the license can be reused for the affected field device 110, 208 or another field device 110, 208. In this example, the process 312 ends. If and/or when the license management circuitry 200 does not receive notification of an input error (block 806: NO), the license management circuitry 200 assists the end user with help of the remote view as needed (block 810). In this example, the process 312 ends.

FIG. 9 is a block diagram of an example programmable circuitry platform 900 structured to execute and/or instantiate the example machine-readable instructions and/or the example operations of FIGS. 3-8 to implement the license management system of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAS, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the license management circuitry 200 and the interface circuity 202.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 3-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 3-8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 3-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus.

Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1(L 1 ) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowchart(s) of FIGS. 3-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 3-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-8. As such, the FPGA circuitry 1100 may be configured and/or structured to effectively instantiate some or all of the operations/functions corresponding to the machine-readable instructions of the flowchart(s) of FIGS. 3-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 3-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 3-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowchart(s) of FIGS. 3-8 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIG. 3-8, and/or an ASIC may be configured and/or structured to perform third operation(s)/function(s) corresponding to a third portion of the machine-readable instructions represented by the flowcharts of FIGS. 3-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

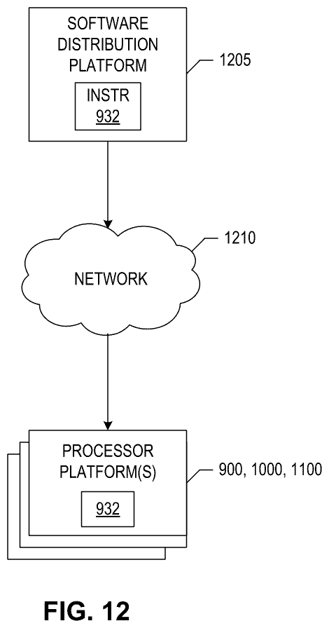

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions of FIGS. 3-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 932 from the software distribution platform 1205. For example, the software, which may correspond to the example machine-readable instructions of FIG. 3-8, may be downloaded to the example programmable circuitry platform 900, which is to execute the machine-readable instructions 932 to implement the license management system. In some examples, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable management of licenses of field devices in a process control system to prevent tampering, unauthorized implementation of licenses, and out-of-sync field devices. Disclosed systems, apparatus, articles of manufacture, and methods are accordingly directed to one or more improvement(s) in the operation of a machine such as a computer or other electronic and/or mechanical device and a network of such devices.

Concepts disclosed herein can be expanded beyond licenses and used to alert the customers with respect to firmware and other aspects of devices. Thus, examples disclosed herein can be used to centralize both the license management and asset management.

Examples systems, apparatus, articles of manufacture, and methods are disclosed for licenses management of field devices in process control systems. Example 1 includes an apparatus that includes interface circuitry; instructions; and processor circuitry to be programmed by the instructions to: identify a field device of a plurality of field devices in a process control system; determine a first version of a license of the field device; and in response to a request to change the first version of the license to a second version of the license: compare the second version of the license to a current version of the license; enable: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and deny either transmission of the second version of the license to the field device or download of the second version of the license to the transportable memory device when the second version does not match the current version.
Example 2 includes the apparatus of Example 1, wherein the processor circuitry is to cause presentation of an alert when the second version of the license does not match the current version.
Example 3 includes the apparatus of Examples 1 or 2, wherein the processor circuitry is to identify ones of the field devices with licenses that are out of sync with current respective versions of the licenses for the field devices.
Example 4 includes the apparatus of any of Examples 1-3, wherein the processor circuitry is to generate a report based on the identified field devices.
Example 5 includes the apparatus of any of Examples 1-4, wherein the processor circuitry is to generate a hash signature when the field device is air-gapped and associate the hash signature with the field device.
Example 6 includes the apparatus of any of Examples 1-5, wherein the processor circuitry is to access a database of current licenses from different vendors of the field devices.
Example 7 includes the apparatus of any of Examples 1-6, wherein the processor circuitry is to associate a first vendor as a servicing agent for multiple ones of the field devices, wherein one or more of the multiple ones of the field devices are obtained from a second vendor.
Example 8 includes the apparatus of any of Examples 1-7, wherein the processor circuitry is configured to generate a report of field devices and associated licenses based on one or more of a location of the field devices, a geographic region, an owner of the field devices, and a user of the field devices.
Example 9 includes the apparatus of any of Examples 1-8, wherein the processor circuitry is to credit a license for a damaged field device and enable the credited license to be transferred to another field device.
Example 10 includes the apparatus of any of Examples 1-9, wherein the processor circuitry is to credit a license based on an input error.
Example 11 includes at least one non-transitory machine-readable storage medium that includes instructions to cause at least one processor circuit to at least: identify a field device of a plurality of field devices in a process control system; determine a first version of a license of the field device; and in response to a request to change the first version of the license to a second version of the license: compare the second version of the license to a current version of the license; enable: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and deny either transmission of the second version of the license to the field device or download of the second version of the license to the transportable memory device when the second version does not match the current version.
Example 12 includes the at least one non-transitory machine-readable medium of Example 11, wherein the machine-readable instructions are to cause one or more of the at least one processor circuit to identify ones of the field devices with licenses that are out of sync with current respective versions of the licenses for the field devices.
Example 13 includes the at least one non-transitory machine-readable medium of Example 11 or 12, wherein the machine-readable instructions are to cause one or more of the at least one processor circuit to generate a hash signature when the field device is air-gapped and associate the hash signature with the field device.
Example 14 includes the at least one non-transitory machine-readable medium of any of Examples 11-13, wherein the machine-readable instructions are to cause one or more of the at least one processor circuit to: access a database of current licenses from different vendors of the field devices; and associate a first vendor as a servicing agent for multiple ones of the field devices, wherein one or more of the multiple ones of the field devices are obtained from a second vendor.
Example 15 includes the at least one non-transitory machine-readable medium of any of Examples 11-14, wherein the machine-readable instructions are to cause one or more of the at least one processor circuit to generate a report of field devices and associated licenses based on one or more of a location of the field devices, a geographic region, an owner of the field devices, and a user of the field devices.
Example 16 includes the at least one non-transitory machine-readable medium of any of Examples 11-15, wherein the machine-readable instructions are to cause one or more of the at least one processor circuit to credit a license for a damaged field device and enable the credited license to be transferred to another field device.
Example 17 includes a method that includes identifying a field device of a plurality of field devices in a process control system; determining a first version of a license of the field device; receiving a request to change the first version of the license to a second version of the license; comparing the second version of the license to a current version of the license; enabling, by executing instructions with a processor: (1) transmission of the second version of the license to the field device when (a) the second version of the license matches the current version of the license and (b) the field device is communicatively coupled to the processor circuitry; or (2) download of the second version of the license to a transportable memory device when (a) the second version of the license matches the current version of the license and (b) the field device is air-gapped relative to the processor circuitry; and denying, by executing instructions with the processor, either transmission of the second version of the license to the field device or download of the second version of the license to the transportable memory device when the second version does not match the current version.
Example 18 includes the method of Example 17, further including generating a hash signature when the field device is air-gapped and associate the hash signature with the field device.
Example 19 includes the method of Example 17 or 18, wherein the current licenses of the field devices are from different vendors of the field devices, the method including associating a first vendor as a servicing agent for multiple ones of the field devices, wherein one or more of the multiple ones of the field devices are obtained from a second vendor.
Example 20 includes the method of any of Examples 17-19, further including: crediting a license based on (a) a damaged field device or (b) an input error; and enabling re-use of the credited license.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

The status of the claims:

1. An apparatus comprising:
interface circuitry;
instructions; and
processor circuitry to be programmed by the instructions to:
identify a field device of a plurality of field devices in a process control system;
determine a first version of a license of the field device; and
in response to a request to change the first version of the license to a second version of the license:
compare the second version of the license to a current version of the license;
cause the field device to use the second version of the license by enabling:
(1) transmission of the second version of the license to the field device when (a) the second version of the license matches the current version of the license and (b) the field device is communicatively coupled to the processor circuitry; or
(2) download of the second version of the license to a transportable memory device when (a) the second version of the license matches the current version of the license and (b) the field device is air-gapped relative to the processor circuitry; and
cause the field device to use the current version by:
alerting the user that the second version does not match the current version;
denying either transmission of the second version of the license to the field device or download of the second version of the license to the transportable memory device when the second version does not match the current version; and
enabling (1) transmission of the current version of the license to the field device when the field device is communicatively coupled to the processor circuitry; and (2) download of the current version of the license to the transportable memory device when the field device is air-gapped relative to the processor circuitry.

2. (canceled)

3. The apparatus of claim 1, wherein the processor circuitry is to identify ones of the field devices with licenses that are out of sync with current respective versions of the licenses for the field devices.

4. The apparatus of claim 3, wherein the processor circuitry is to generate a report based on the identified field devices.

5. The apparatus of claim 1, wherein the processor circuitry is to generate a hash signature when the field device is air-gapped and associate the hash signature with the field device.

6. The apparatus of claim 1, wherein the processor circuitry is to access a database of current licenses from different vendors of the field devices.

7. The apparatus of claim 6, wherein the processor circuitry is to associate a first vendor as a servicing agent for multiple ones of the field devices, wherein one or more of the multiple ones of the field devices are obtained from a second vendor.

8. The apparatus of claim 1, wherein the processor circuitry is configured to generate a report of field devices and associated licenses based on one or more of a location of the field devices, a geographic region, an owner of the field devices, and a user of the field devices.

9. The apparatus of claim 1, wherein the processor circuitry is to credit a license for a damaged field device and enable the credited license to be transferred to another field device.

10. The apparatus of claim 1, wherein the processor circuitry is to credit a license based on an input error.

11. At least one non-transitory machine-readable storage medium comprising instructions to cause at least one processor circuit to at least:
identify a field device of a plurality of field devices in a process control system;
determine a first version of a license of the field device; and
in response to a request to change the first version of the license to a second version of the license:
compare the second version of the license to a current version of the license;
cause the field device to use the second version of the license by enabling:
(1) transmission of the second version of the license to the field device when (a) the second version of the license matches the current version of the license and (b) the field device is communicatively coupled to the processor circuitry; or
(2) download of the second version of the license to a transportable memory device when (a) the second version of the license matches the current version of the license and (b) the field device is air-gapped relative to the processor circuitry; and
cause the field device to use the current version by:
denying either transmission of the second version of the license to the field device or download of the second version of the license to the transportable memory device when the second version does not match the current version; and
enabling (1) transmission of the current version of the license to the field device when the field device is communicatively coupled to the processor circuitry; and (2) download of the current version of the license to the transportable memory device when the field device is air-gapped relative to the processor circuitry.

12. The at least one non-transitory machine-readable medium of claim 11, wherein the machine-readable instructions are to cause one or more of the at least one processor circuit to identify ones of the field devices with licenses that are out of sync with current respective versions of the licenses for the field devices.

13. The at least one non-transitory machine-readable medium of claim 11, wherein the machine-readable instructions are to cause one or more of the at least one processor circuit to generate a hash signature when the field device is air-gapped and associate the hash signature with the field device.

14. The at least one non-transitory machine-readable medium of claim 11, wherein the machine-readable instructions are to cause one or more of the at least one processor circuit to:
access a database of current licenses from different vendors of the field devices; and
associate a first vendor as a servicing agent for multiple ones of the field devices, wherein one or more of the multiple ones of the field devices are obtained from a second vendor.

15. The at least one non-transitory machine-readable medium of claim 11, wherein the machine-readable instructions are to cause one or more of the at least one processor circuit to generate a report of field devices and associated licenses based on one or more of a location of the field devices, a geographic region, an owner of the field devices, and a user of the field devices.

16. The at least one non-transitory machine-readable medium of claim 11, wherein the machine-readable instructions are to cause one or more of the at least one processor circuit to credit a license for a damaged field device and enable the credited license to be transferred to another field device.

17. A method comprising:
identifying a field device of a plurality of field devices in a process control system;
determining a first version of a license of the field device;
receiving a request to change the first version of the license to a second version of the license;
comparing the second version of the license to a current version of the license;
causing the field device to use the second version of the license by enabling, by executing instructions with a processor:
(1) transmission of the second version of the license to the field device when (a) the second version of the license matches the current version of the license and (b) the field device is communicatively coupled to the processor circuitry; or
(2) download of the second version of the license to a transportable memory device when (a) the second version of the license matches the current version of the license and (b) the field device is air-gapped relative to the processor circuitry; and
causing the field device to use the current version by:
denying, by executing instructions with the processor, either transmission of the second version of the license to the field device or download of the second version of the license to the transportable memory device when the second version does not match the current version; and
enabling, by executing instructions with the processor, (1) transmission of the current version of the license to the field device when the field device is communicatively coupled to the processor circuitry; and (2) download of the current version of the license to the transportable memory device when the field device is air-gapped relative to the processor circuitry.

18. The method of claim 17, further including generating a hash signature when the field device is air-gapped and associate the hash signature with the field device.

19. The method of claim 17, wherein the current licenses of the field devices are from different vendors of the field devices, the method including associating a first vendor as a servicing agent for multiple ones of the field devices, wherein one or more of the multiple ones of the field devices are obtained from a second vendor.

20. The method of claim 17, further including:
crediting a license based on (a) a damaged field device or (b) an input error; and
enabling re-use of the credited license.
